(19) United States
(12) Patent Application Publication
(10) Pub. No.: US 2007/0143283 A1
(43) Pub. Date: Jun. 21, 2007

(54) METHOD OF OPTIMIZING SEARCH ENGINE RANKINGS THROUGH A PROXY WEBSITE

(76) Inventors: Stephan Spencer, Lyttelton (NZ); David Cooper, Torbay (NZ); Brian Klais, Mt. Horeb, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/608,473

(22) Filed: Dec. 8, 2006

Related U.S. Application Data
(60) Provisional application No. 60/749,116, filed on Dec. 9, 2005.

(51) Int. Cl. G06F 17/30

(52) U.S. Cl. 707/5

(57) ABSTRACT

A system and method for optimizing the rankings of web pages of a commercial website within search engine keyword search results. A proxy website is created based on the content on the commercial website. When a search engine spider reaches the commercial website, the commercial website directs the search engine spider to the proxy website. The proxy website includes a series of proxy web pages that correspond to web pages on the commercial website along with modifications that enhance the rankings of the pages by the search engines. However, hyperlinks containing complex, dynamic URLs are replaced with spider-friendly versions. When a human visitor selects a proxy web page listing on the search engine results page, that visitor is directed to the proxy web page. The proxy server delivers the same content to the human visitor as to the search engine spider, only with simplified URLs for the latter.

### CROSS REFERENCE TO RELATED APPLICATION

The present application is based on and claims priority to U.S. Provisional Patent Application Ser. No. 60/749,116, filed on Dec. 9, 2005.

### BACKGROUND OF THE INVENTION

The present disclosure generally relates to a method and system for improving the rankings of web pages on search engines in the natural or algorithmic (unpaid) search results section. More specifically, the present disclosure relates to a method and system for optimizing the content, HTML and internal linking structure of a website through a proxy server on both a sitewide and a page-specific basis, thus allowing search engines to index a variation of a website that is better suited to ranking highly in the algorithmic results of the search engines.

Presently, search engines, such as Google, Yahoo or Windows Live Search, utilize a “crawler” or “spider” that traverses the World Wide Web and indexes web pages into a large database based upon the content and words on the web pages. The indexing and ranking of web pages by the search engine is based, in part, upon an algorithm developed by the search engine that takes into account both visible and hidden terms included on the web pages accessed by the spider.

Sometimes search engines avoid indexing web pages that include dynamic, database-generated content or that have URLs containing “stop characters”—ampersands, equals signs, or question marks. Many e-commerce platforms dynamically create product web pages when a shopper requests them. These dynamic product pages are populated with content from a database, retrieved using database queries that are based in part on values within the URL. For many e-commerce platforms, these values are placed within the query string portion of the URL. Many search engine spiders are configured to avoid overly complex URLs with multiple parameters in the query string. Thus, if a commercial website maintained by a retailer includes dynamic web pages or complicated URLs, the search engine spider may avoid the web pages altogether, thus preventing the information on the web page from being indexed by the search engine.

Further, even if a web page has been indexed by a search engine, it does not necessarily mean that the page will appear on the first page of search results when a search engine user performs a query. Since the first listings in the search results are most often selected by the user, it is extremely desirable for a website owner to have their web page listed at or near the top of the search result list returned by the search engine.

The ranking of web pages within the search engine results depends upon numerous factors, including the presence, location, and repetition on the web page of the words/phrases entered by the search engine user into the search engine (the “search terms”). If a web page can be revised to optimize the number of occurrences and placement of search terms for which the website owner desires higher rankings in the search engines, the website can influence the rankings of the search engine.

In order to enhance the rankings of web pages within the search engine results, various different techniques have been developed, many of which are currently discouraged or penalized by the most popular search engines such as Google, Yahoo or Windows Live Search. One technique detects whether a human web visitor or search engine spider is attempting to access the website. If the website determines that a human visitor is attempting to access the site, that human visitor is directed to a dynamic page, while the search engine spider is instead directed to a keyword-rich “doorway page” for indexing. In effect, this type of system feeds different content to the search engine spider than to the human customer. This type of redirection system is discouraged by the most popular search engines and is used by some search engine optimizers (SEOs) to manipulate the search engine.

The nature of changes required to so enhance search engine rankings are generally highly invasive and cost-prohibitive for managers of large commercial websites. For instance, re-structuring a website's underlying E-commerce platform, and the manner in which it passes information through the URL to create and process user actions, requires significant effort and corporate coordination. In fact, for many commercial websites, this particular maneuver, as an example, is impossible due to technical constraints.

Therefore, a need exists for a method and system for optimizing a dynamic commercial website to be better crawled, indexed and highly ranked by the search engines in a way that falls within the guidelines of the most common commercial search engines, yet without requiring changes be made to the commercial website's e-commerce platform or database.

### SUMMARY OF THE INVENTION

The present disclosure presents a system and method of optimizing the indexing and ranking of dynamic web pages of a commercial website on the results page of the most commonly used internet search engines. The method of the present disclosure provides a search engine optimized version of the commercial website that is more easily crawled by the search engine spider, thus increasing the indexing and ranking of the web pages on the search results page.

Initially, a proxy website is created that generally corresponds to the commercial website. The proxy website includes proxy web pages that include substantially the same informational content as the web pages of the commercial website. However, when the proxy web pages are requested, the dynamic URLs and hyperlinks with dynamic URLs are algorithmically processed and revised in real-time by the proxy server to be more spider-friendly. The introduction of simplified URLs—devoid of stop characters—into the HTML of the web pages of the proxy website enhances the ability of a search engine spider to comprehensively crawl the web pages on the proxy website, thus increasing both the indexing and ranking of the proxy web pages.

In accordance with the present disclosure, the commercial website is configured to have one or multiple links to the proxy website, to direct search engine spiders to the proxy website. The hyperlinks from the commercial website to the proxy website can either be constantly present on the web pages of the commercial website or can replace the typical hyperlinks on the commercial website upon detection of the search engine spider. In such a configuration, when the commercial web server detects the search engine spider, the hyperlinks contained on the web pages of the commercial website are replaced with hyperlinks with simplified, spider-friendly URLs that direct the search engine spider to proxy web pages on the proxy website.

When either the search engine spider or a human visitor request a proxy web page from the proxy website using its simplified spider-friendly URL, the proxy server retrieves the corresponding web page from the commercial website. Hyperlinks contained in the HTML of the web page from the commercial website are modified to be more spider-friendly, where hyperlinks with dynamic URLs that correspond to the commercial web pages are replaced with hyperlinks directed to proxy web pages. The replacement of the dynamic URLs and hyperlinks on the proxy website provides a more spider-friendly site for crawling by the search engine spider.

The content contained on the proxy web pages is the same when the proxy web page is accessed either by the search engine spider or by the human visitor. The presentation of the same web page content to both the search engine spider and the human visitor allows the proxy website to stay within the “no cloaking” guidelines set by most commonly used search engines.

Since the proxy web pages are contained on a proxy website separate from the commercial website, additional content and HTML optimization can be added to the proxy web pages that are not included on the corresponding web pages on the commercial site, via a web-based interface. The addition of this content and HTML optimization on the proxy web pages can be utilized to enhance the ranking of the proxy web pages on the search engine results pages. The effect of the addition of these optimizations on ranking can be analyzed and the content can then be revised to further enhance the ranking of the proxy web page. By utilizing the proxy web pages rather than the web pages contained on the commercial website, the rankings and functionality of the proxy web pages can be enhanced without altering the commercial web pages.

### BRIEF DESCRIPTION OF THE DRAWINGS

The drawings illustrate the best mode presently contemplated of carrying out the invention. In the drawings:

FIG. 1 is a schematic illustration of the proxy website and the commercial website that is being optimized;

FIG. 2 is a sample screenshot showing the search results page of a search engine illustrating the ranking of results from a search query;

FIG. 3 is a screenshot of a commercial website that includes multiple product categories;

FIG. 4 is a screenshot of the proxy website corresponding to the commercial website of FIG. 3 including the same product categories;

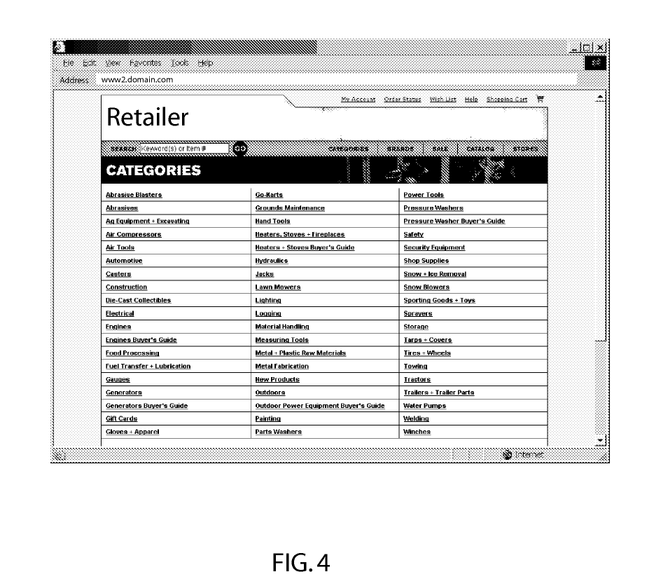

FIG. 5 is a flowchart illustrating the steps taken upon the receipt of a request for a web page, such as the home page, at a commercial website;

FIG. 6 is a flowchart illustrating the operational steps upon receipt of a request at the proxy website; and

FIG. 7 is a flowchart illustrating the steps for optimizing a proxy web page.

### DETAILED DESCRIPTION OF THE INVENTION

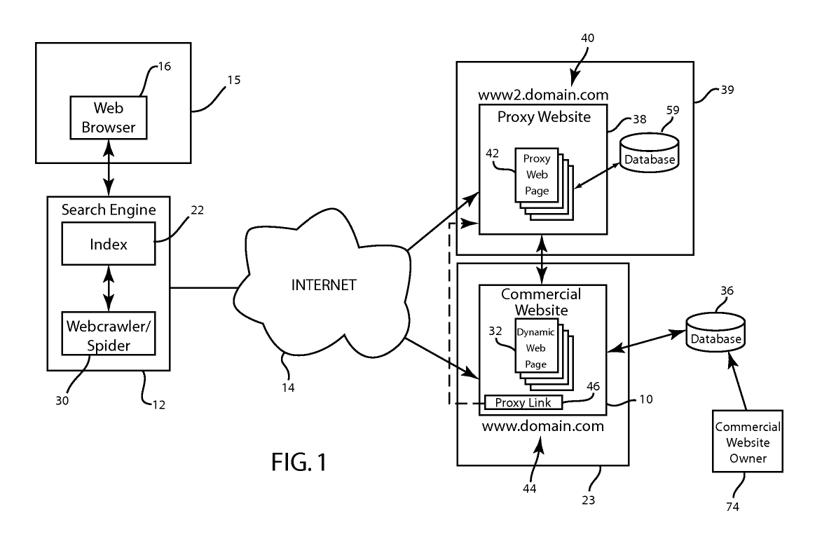

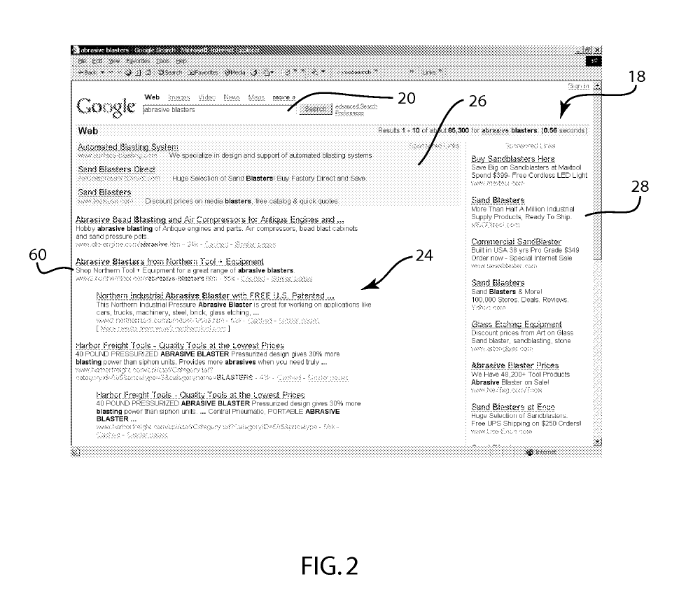

Referring first to FIG. 1, thereshown is the communication configuration between a commercial website 10 and a search engine 12 through a wide area network (WAN), such as the internet 14. As is well known, the search engine 12 allows a human visitor 15, through a web browser 16, to enter a search query into a graphical user interface. Based upon the search terms entered into the web browser 16, the search engine 12 generates a search results page 18 shown in FIG. 2. In the example shown in FIG. 2, the search results page 18 is from the popular search engine Google®, although other search results pages from commonly used search engines such as Yahoo, Windows Live Search, or others, are contemplated being within the scope of the present invention.

As illustrated in FIG. 2, the search results page 18 includes a search entry field 20 that allows the visitor to enter search terms. After the search terms have been entered, the search engine consults an index 22 and returns natural search results 24 that include previously indexed commercial web pages that typically include the search terms used by the search engine visitor in the query. The web pages shown in the natural search results 24 are ranked based upon the search engine's relevancy criteria and ranking algorithm. These relevancy criteria can vary depending upon the search engine, but typically the search terms appear within the individual web pages. As can be clearly understood and is well known in the search engine marketing industry, getting a commercial website both indexed and ranked as high as possible in the natural search results 24 greatly enhances the amount of sales generated by the commercial website. Typically, getting a commercial website ranked highly within the natural search results 24 requires the effective use of metadata, keywords, templates, site navigation and cross-linking. Typically, changing any one of these parameters requires complex changes at the commercial website, which is often difficult or restricted by the website owner during peak consumer buying periods, such as during the holiday season.

In addition to the section of natural search results 24, the search results page 18 shown in FIG. 2 also includes two separate advertising sections 26 and 28. Each of these advertising sections 26, 28 allows a retailer to purchase keywords such that when these keywords are entered into the search query entry field 20, the retailer's web pages are listed in the sections shown. The ranking and indexing of a commercial website within the natural search results 24 depends solely upon the algorithms used by the search engine, thus allowing for the optimization of the commercial website to enhance the ranking of the commercial website within the natural search results 24.

Referring back to FIG. 1, typical search engines 12 include a web crawler or spider 30 whose sole purpose is to “crawl” the internet 14 and place web pages and their content into its index 22, to later compare with search terms entered in queries by human visitors 15. As illustrated in FIG. 1, the spider 30 accesses the commercial website 10 maintained on the server 23 through the internet 14 and, upon reaching the commercial website 10, attempts to access all of the pages 32 and information contained within the commercial website 10.

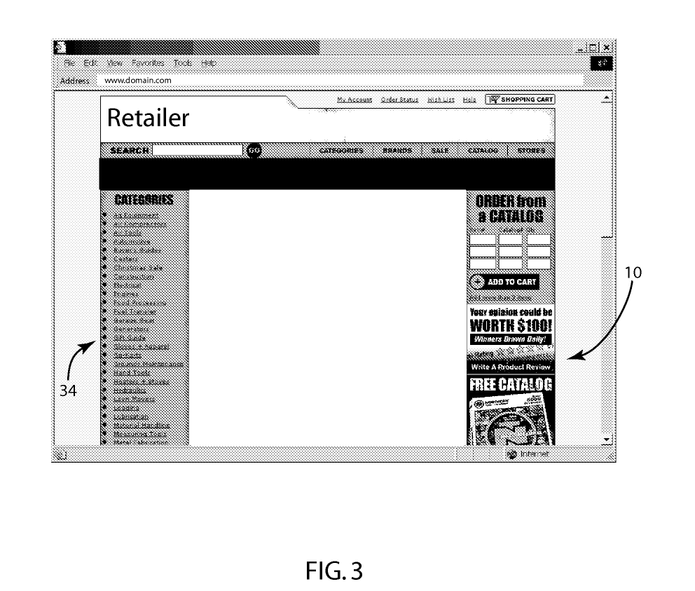

Presently, many online retailers utilize e-commerce platforms that dynamically generate web pages 32 upon request. FIG. 3 illustrates a typical commercial website 10. Included in the commercial website 10 is a listing of product categories 34, each of which includes a hyperlink to a dynamically-generated web page contained further within the commercial website 10. When a customer selects one of the hyperlinks contained within the product categories 34, the commercial website accesses its product database 36 (FIG. 1) that includes product information, such as pricing, stock availability and product photos. Since each of the web pages 32 including product information is dynamic, when a visitor 15 requests a product web page, the dynamic product web page 32 incorporates the most up-to-date information on the product, as stored in the commercial website database 36.

Although dynamic web pages 32 are effective in presenting up-to-date information to a human visitor 15, search engine spiders 30 avoid dynamic, complex URLs since the automated spiders 30 can become trapped in a repeating loop within the commercial website 10, requesting and obtaining the same content over and over again but at differing URLs. Therefore, commercial websites that include dynamic, complex URLs are not search-engine-spider-friendly and are much less likely to be indexed and, even if indexed, typically result in low rankings within the search results page 18.

In accordance with the present invention, a proxy website 38 is developed and is delivered using a proxy server 39. The proxy website 38 includes a series of proxy web pages 42 that generally correspond to the dynamic web pages 32 contained on the commercial website 10. The proxy web pages 42 can include product pages, product category pages and other pages present on the commercial website 10. The proxy website 38 can be located either under the same subdomain as the commercial website 10 or a different one, depending on the system configuration. In the embodiment listed, the subdomain 40 of the proxy website 38 closely resembles the subdomain 44 of the commercial website 10. However, the subdomain 40 for the proxy website 38 could be any name. Having the subdomain 40 reside under the main domain name 44 of the commercial website 10 will prevent customer confusion when the web address is presented to the human visitor 15 on the search results page 18.

The proxy server 39 is designed to receive and respond to requests for pages from search engine spiders 30 and web browsers 16, in particular the web browser 16 of the search engine's visitors. The proxy server 39 is programmed to pass through certain elements of the commercial website 10 unaltered and in real-time, with other elements being replaced with optimized alternatives. The proxy server 39 may at times store or cache pages, but optimization is preferably applied in real-time to the proxy web pages 42.

In accordance with one embodiment of the present disclosure, when a search engine spider 30, such as Googlebot, reaches a company's commercial website 10, the search engine spider 30 encounters a hyperlink 46 pointing to pages 42 on the proxy website 38 that are delivered by the proxy server 39. As an example, the hyperlink 46 could either point to the company's “www” subdomain or another subdomain under the company's domain, such as “www2”. Once the search engine spider 30 reaches the proxy website 38, the search engine spider 30 is confronted with alternative hyperlinks containing spider-friendly URLs that point to web pages 42 deeper within the proxy website 38.

Presently, there are three ways contemplated that the search engine spider 30 can encounter hyperlinks to the proxy website 38 from the commercial website 10. The first is through hyperlinks 46 that are always included on the commercial website 10, especially on the home page of the commercial website 10.

Another contemplated way for the spider 30 to reach the proxy website 38 from the commercial website 10 is through hyperlinks to proxy web pages 42 that are included on the commercial website 10, on pages such as the home page, only when a search engine spider 30 is accessing the commercial website 10. Such specifically created hyperlinks serve as replacements to hyperlinks to the corresponding web pages on the commercial website 10.

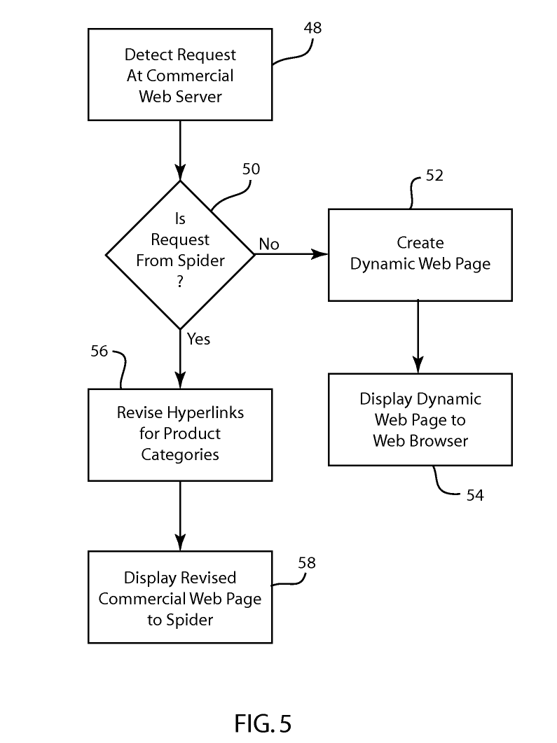

Referring now to FIG. 5, thereshown is the operation of the commercial website 10 once the commercial website 10 detects a request for a web page, as illustrated in step 48. Once the commercial web server 23 detects the request, the commercial web server 23 first must determine whether the request is from a spider, as illustrated by step 40. If the commercial web server 23 determines that the request is not from a search engine spider 30, but instead from a web browser 16, the commercial web server 23 generates the requested dynamic web page in step 52, as per normal. As indicated previously, the dynamic web page 32 is generated on-the-fly by utilizing information contained within the commercial website's database 36. Once the dynamic web page 32 has been created in step 52, the dynamic web page 32 is delivered to the web browser 16 in step 54.

If the commercial web server 23 determines in step 50 that the request is from a search engine spider 30, the commercial web server 23 revises some of the hyperlinks on the dynamic web page 32 to make the URLs more spider-friendly. Specifically, some of the hyperlinks and URLs contained on the commercial website 10 are replaced with hyperlinks and URLs directed to corresponding proxy web pages 42 contained on the proxy website 38, either with the aid of the proxy server 39 or a program installed on the commercial web server 23. Thus, if the commercial web server 23 detects the search engine spider 30, the search engine spider 30 will be directed into the proxy website 38 that is more spider-friendly, for further “crawling”.

The third approach to link the commercial website 10 to the proxy website 38 is through JavaScript-based hyperlinks. With JavaScript enabled, as is typically the case for web browsers 16, the URLs in the hyperlinks refer to the commercial website 10. The search engine spiders 30, however, which typically are unable to fully process JavaScript, would encounter URLs that refer to the proxy website 38.

In the most basic configuration, the proxy server 39 obtains, in real-time, the requested web page 32 from the commercial website 10 and revises some of the hyperlinks contained within the page 32 to be more spider-friendly and to point back to other corresponding pages 42 within the proxy website 38. The corresponding web pages 42 on the proxy website 38 are based on the same content as that which is included on the corresponding web pages 32 of the commercial website 10 but are optimized by simplified URLs in the hyperlinks and optimizations as defined in a proxy database 59.

Since search engine spiders 30 are cautious of dynamic web pages 32, particularly ones which utilize very complex URLs containing multiple stop characters, the commercial web pages 32 are revised by the proxy server 39 to create the proxy web pages 42 so as not to appear to be dynamically generated by eliminating, as much as possible, complex URLs within hyperlinks contained on these web pages.

In accordance with the disclosure, hyperlinks 46 contained within the commercial website 10 direct the search engine spider 30 to the proxy website 38 that includes proxy web pages 42 corresponding to those included on the commercial website 10. The proxied web pages 42 are optimized to simplify the URLs such that the search engine spider 30 is able to crawl through all the content included on the proxy website 38.

As illustrated in FIG. 1, when a human visitor 15 performs a query on a search engine 12, such as Google, the human visitor 15 is presented with search results in the form of a ranked list of web pages, as shown in the search results page 18 of FIG. 2. When the search results 24 includes a page 60 from the proxy website 38 and the human visitor 15 clicks on the link for the proxy web page 60, the human visitor 15 is directed to the proxy website 38. The selected web page 42 on the proxy website 38 includes substantially the same content as the corresponding page 32 on the commercial website 10, but with revisions based on page-specific optimization rules stored the proxy database 59, as shown. Thus, when the human visitor 15 views the proxy website 38, the visitor 15 is presented with a similar but not identical version of the web page 32 present on the commercial website 10.

In one embodiment of the system, hyperlinks containing dynamic URLs can be made spider-friendly for human visitors 15, not just search engine spiders 30. As such, if the human visitor 15 clicks on a hyperlink on a proxy web page 42 on the proxy website 38, the visitor 15 will be directed to another web page 42 on the proxy website 38. The “add to cart” and “check out” features would still hyperlink directly to the commercial website 10 so that the proxy server 39 would not need all the operation characteristics of an e-commerce platform such as credit card processing. However, in its preferred configuration, the proxy server 39 directs the human visitor 15 in all instances to the commercial website 10 and away from the proxy website 38 upon selecting a hyperlink on a web page 42 on the proxy website 38.

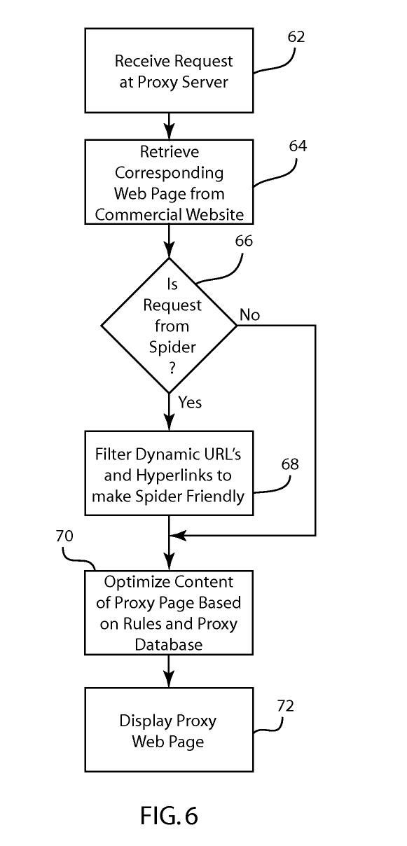

FIG. 6 illustrates the sequence of operation when the proxy website receives a request for a proxy web page 42 from either the human visitor 15 or the search engine spider 30.

As illustrated in step 62, when the proxy server 39 receives a page request, the proxy server 39 retrieves the corresponding web page 32 from the commercial website 10 in step 64. Once the proxy server 39 retrieves the web page 32 from the commercial website 10, the proxy server 39 determines in step 66 whether the request is from a spider 30 or a human visitor 15. If the request is from a spider, the proxy server 39 revises hyperlinks containing dynamic URLs to be more spider-friendly in step 68. Specifically, those hyperlinks to web pages 32 on the commercial website 10 are made to point instead to corresponding proxy pages 42 on the proxy website 38, as illustrated in step 68. The reduction of hyperlinks containing complex URLs makes the proxy page 42 much more spider-friendly, as described previously.

Once the dynamic URLs and hyperlinks have been revised in step 68, the proxy server accesses the proxy database 59 to optimize the content of the proxy web pages based upon rules and content included in the proxy database 59, as illustrated in step 70. As an example, optimized content, such as additional or different page titles, keyword choices and text can be inserted into the proxy web pages prior to the web page being served to the spider 30 or the human visitor 15. The use of the additional content on the proxy web page as compared to the commercial web page will enhance the ranking of the proxy web pages within the search results of the search engine 12.

Once the proxy web page has been created, the proxy web page is served to the spider in step 72. Alternatively, if the system determines in step 66 that the request for the proxy web page was from a human visitor rather than from a spider, the proxy server 39 displays the proxy web page without revising the dynamic URLs but with the additional optimized content added to the proxy page. Thus, the proxy web page shown to the human visitor 15 will be more similar to the dynamic web page 32 contained on the commercial website 10.

By utilizing the proxy website 38, the commercial website owner 74 is able to increase the indexation of his content in the search engine 12 while still presenting the human visitor 15 with the same information as available on the commercial website 10. However, the proxy server 39 simplifies URLs within hyperlinks on each web page 42 such that the search engine spider 30 can more easily crawl the proxy website 38, as compared to the commercial website 10.

In accordance with the present disclosure, when either a spider 30 or a human visitor 15 access the proxy website 3 8, both the spider 30 and the human visitor 15 are presented with the same content; only the hyperlinks containing dynamic URLs are made more spider-friendly. The same holds true for when spiders 30 or visitors 15 access the commercial website 10.

In accordance with the present disclosure, the proxy website 38 can also be optimized to influence the ranking of the web pages in the search results delivered by the search engine 12, as shown by step 70 of FIG. 6. As an example, page titles, body copy, internal linking structures, keyword choices, and so forth can be optimized on the proxy web pages 42 on the proxy website 3 8 to enhance the ranking of these web pages. The use of the proxy website 3 8 to include these optimization techniques, rather than modifying the actual commercial website 10, increases the ability of the commercial website owner 74 to improve their search engine rankings without having to modify the commercial website 10, which could be much more difficult or restricted by corporate policy during peak purchasing seasons.

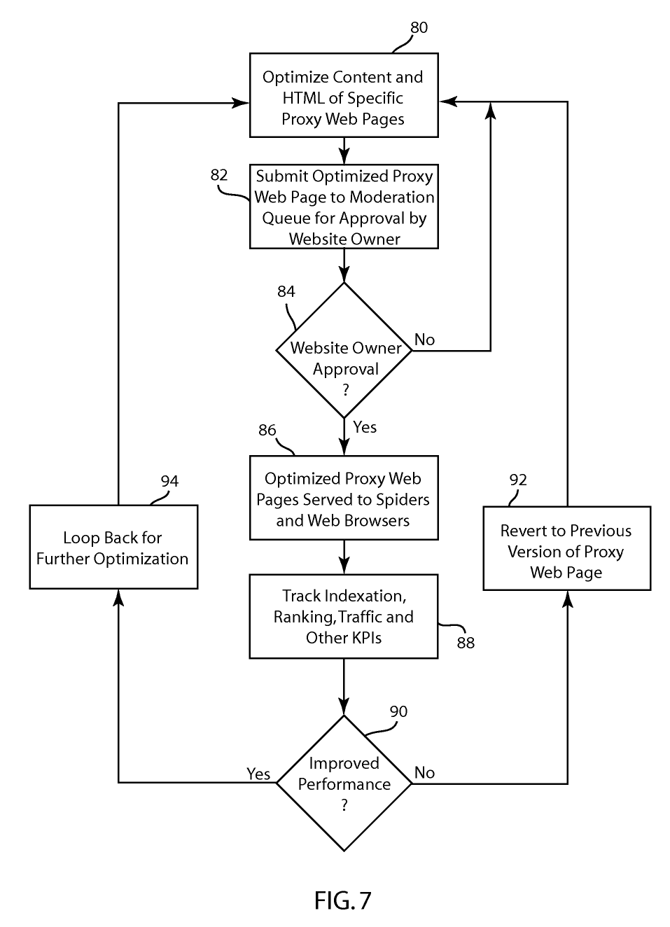

FIG. 7 illustrates a method of optimizing the content and HTML of the proxy web pages 42 to enhance the ranking of the proxy web pages 42 on a search engine 12. As indicated in step 80 of FIG. 7, a web marketer working for either the commercial website owner 74 or a third party vendor can revise the content of specific proxy web pages 42 to include optimized content that will aid in influencing the rank of the proxy web pages in the search results delivered by a search engine 12. As discussed above, such content revisions could include different or additional page titles, body copy, internal linking structures, keyword choices and so forth, that may enhance the ranking of the web pages 42 within the results of various different search engines.

If the optimized content added to the specific web pages is being added by a third party vendor, it is desirable to present the optimized proxy web pages to the commercial website owner 74 for review before the optimized proxy web pages become “live” and accessible by both a human visitor 15 and the spider 30. As illustrated in step 82, the optimized proxy web pages are submitted to a moderation queue contained within the proxy web server 39. Preferably, the moderation queue is an area on the proxy web server that is password controlled and can be accessed by the commercial website owner 74 to preview the proxy web page prior to the proxy web page becoming active. If the website owner does not approve the optimization done to the proxy web pages, as indicated in step 84, the system returns to step 80, where additional/different optimized content can be added to the proxy web pages for review by the commercial website owner. This process is repeated until the website owner approves the optimization done to the proxy web page in step 84.

Once the optimized content of the proxy web pages is approved, the optimizations are set to the “approved” status in the proxy database 59 and the optimized version of the proxy web pages are served to both spiders and human visitors, as illustrated in step 86. As the optimized proxy web pages are served to both spiders and web browsers, the system tracks the indexation, ranking, traffic and other key performance indicator metrics that are associated with the proxy web pages, as illustrated in step 84. Based upon the tracked parameters, the system can generate reports and graphs in a web-based interface that provides insight as to the results the optimized content has on enhancing the ranking of the proxy web pages within the various different search engines. By utilizing the method shown in FIG. 7, optimized content can be added to the proxy web pages, reviewed by the website owner and, once approved, tracked to determine whether the optimization techniques enhanced the rankings of the web pages as desired.

As illustrated in step 90, if the performance of the proxy web pages does not improve based upon the optimized content, the proxy web pages can be reverted back to the previous version of the proxy web page in step 92 and the system returns to step 80 to attempt different optimization techniques. However, if the performance of the proxy web pages improves, further optimization is conducted in steps 94 and 80 to attempt to further enhance the performance of the proxy web pages. In this manner, the proxy web pages are continuously optimized to develop the best rankings possible for the commercial website owner.

In addition to adding optimized content to the proxy web pages to enhance the ranking of the web pages, it is also contemplated that additional proxy web pages could be added to the proxy website 38 that do not have a corresponding page on the commercial website 10. The additional web pages added to the proxy website 38 could be added specifically to enhance the ranking of the proxy website 38 but would not be required or desired on the commercial website 10.

Referring back to FIG. 1, the proxy website 38 includes numerous web pages 42 that can be revised and created using content revisions within the proxy database 59 as well as known search engine optimization techniques. When a web page 42 on the proxy website 38 is optimized, the revised content is not only served to spiders 30, but also to human visitors 15 that access the proxy website 38 from the search results pages of the search engine 12. Thus, the system of the present disclosure does not run afoul of search engine rules or guidelines regarding the cloaking of content.

As described, content is obtained and revised on the proxy website 38 on a real-time basis when a human visitor 15 or spider 30 requests a web page 42 on the proxy website 38. When a spider 30 or visitor 15 requests a web page 42, the proxy server 39 requests the latest copy of the web page 32 from the commercial website 10 and a customized search-and-replace algorithm is then applied based on information and rules stored in the proxy database 59. The proxy server 39 scans the web page HTML looking for certain strings of characters to replace with optimized content stored in the proxy database 59.

Referring back to FIG. 1, when a human visitor 15 is looking for a product offered on the commercial website 10, the visitor 15 conducts a query on the search engine 12. The search engine 12 generates a set of search results 18 (FIG. 2) that list web pages ranked in an order determined by the search engine 12. If the commercial website 10 offers a product that is also included on the proxy website 38 and that matches the search query, a hyperlink to the proxy website 38 will be included in the search results list, as shown by the link to page 60. Since the search engine 12 obtained the product information from the proxy website 38 rather than directly from the commercial website 10, the hyperlink 60 included in the search results will direct the visitor 15 to the proxy website 38. As described, the web pages 42 included in the proxy website 38 are enhanced with content revisions that improve the likelihood that the page will rank higher in the search results for relevant targeted keywords. The search engine rankings of the proxy website 38 can be monitored and correlated with the various revisions made to the proxy website 38.

When the proxy website 38 receives a request from the visitor 15, the proxy website 38 requests the corresponding web page 32 from the commercial website 10, processes that page through an algorithm that filters any spider un-friendliness and through the database 59 of approved content revisions 23. The proxied web page is then served to the visitor 15.

Once the human visitor 15 has been presented with the proxy web page 42, the visitor 15 can now add the product to their shopping cart within the commercial website 10, which is visible for tracking by the commercial website owner 74. From here, the visitor 15 can complete their purchase, as normal, without the involvement of the proxy website 38.

As described previously, the individual pages on the proxy website 38 can be selectively modified to include additional keywords using known search engine optimization techniques to enhance the ranking of the proxied web pages 42 within the search engine 12. These modification techniques do not modify the actual commercial website 10, but instead only affect the proxy website 20.

We claim:

1. A method of optimizing the indexing and ranking of web pages of a commercial website on a search engine search result page, the method comprising the steps of:
creating a proxy website to correspond to the commercial website, the proxy website having proxy web pages that include substantially the same informational content as the web pages of the commercial website;
providing a hyperlink from the commercial website to the proxy website;
creating the proxy web pages on the proxy website upon a request, each of the proxy web pages including substantially the same informational content as a corresponding web page on the commercial website, the proxy web pages having been algorithmically optimized for presenting simplified URLs and hyperlinks;
adding optimized content to the proxy web pages not present on the corresponding commercial web pages; and
serving the proxy web pages including the optimized content upon a request for the proxy web pages.

2. The method of claim 1 wherein the hyperlink from the commercial website to the proxy website is permanently included on the commercial website.

3. The method of claim 1 wherein the hyperlink from the commercial website to the proxy website is included on the commercial website only upon detection of a search engine spider.

4. The method of claim 1 wherein the web pages on the commercial website include dynamic URLs such that the web pages of the commercial website retrieve product information from a commercial database upon request for the web pages.

5. The method of claim 4 further comprising the steps of:
upon request for a proxy web page, retrieving the corresponding web page from the commercial website; and
algorithmically revising the hyperlinks contained in the web pages from the commercial website to remove dynamic URLs to create the proxy web pages.

6. The method of claim 1 wherein the optimized content additions and revisions to the proxy web page is retrieved from a proxy database.

7. The method of claim 1 further comprising the steps of:
receiving a request for a proxy web page from a web browser at the proxy website;
retrieving the corresponding web page from the commercial website;
processing the web page from the commercial website to remove dynamic URLs to create the proxy web page; and
presenting the proxy web page to the web browser.

8. The method of claim 7 wherein the request from the web browser is received through the search engine results page.

9. The method of claim 1 further comprising the steps of:
detecting whether a request for the commercial website is from a search engine spider; and
replacing hyperlinks on the commercial website with hyperlinks to the corresponding proxy web pages on the proxy website, wherein the hyperlinks to the proxy web pages have simplified URLs.

10. A method of optimizing the rankings of web pages of a commercial website on a search engine search results page, the method comprising the steps of:
creating a proxy website to correspond to the commercial website, the proxy website having proxy web pages including substantially the same content as the web pages of the commercial website;
providing a hyperlink from the commercial website to the proxy website; and
creating the proxy web pages on the proxy website corresponding to each web page on the commercial website, each of the proxy web pages including substantially the same information as the commercial web page, each proxy web page having a simplified URL and simplified hyperlinks compared to the commercial web page; and
adding optimized content to the proxy product web pages not present on the corresponding commercial web pages.

11. The method of claim 10 further comprising the step of tracking the ranking of the proxy web pages on the search engine results page due to the addition or revision of optimized content.

12. The method of claim 11 wherein the hyperlink to the proxy website is permanently included on the commercial website.

13. The method of claim 11 wherein the web pages on the commercial website include dynamic URLs such that the web pages retrieve product information from a commercial database upon access.

14. The method of claim 13 further comprising the steps of:
upon request for a proxy web page, retrieving the corresponding commercial web page from the commercial website;
revising the hyperlinks contained in the commercial web pages to remove dynamic URLs and simplify URLs in hyperlinks to create the proxy web pages; and
retrieving the optimized content from a proxy database.

15. The method of claim 10 wherein the commercial web pages and the proxy web pages include substantially the same product information.

16. The method of claim 10 further comprising the steps of:
receiving a request at the proxy website from a web browser;
retrieving the requested web page from the commercial website;
processing the commercial web page to remove dynamic URLs to create the proxy web page; and
presenting the proxy web page to the web browser.

17. The method of claim 16 wherein the request from the web browser is received from the search engine results page.

18. The method of claim 10 further comprising the steps of:
determining whether a request for the commercial website is from a search engine spider; and
replacing hyperlinks on the commercial website with hyperlinks to the corresponding proxy web pages on the proxy website, wherein the links to the proxy web pages have simplified URLs.

19. A method of optimizing the rankings of web pages of a commercial website on a search engine search results page, the method comprising the steps of:
creating a proxy website corresponding to the commercial website, the proxy website having proxy web pages including substantially the same content as the web pages of the commercial website;
providing a hyperlink from the commercial website to the proxy website;
creating proxy web pages on the proxy website for web pages on the commercial website, each of the proxy web pages including substantially the same information as the corresponding commercial web page, the proxy web pages having a simplified URL and simplified hyperlinks compared to the corresponding commercial web page;
adding optimized content to the proxy web pages that is not present on the corresponding commercial web page;
serving the proxy web pages including the optimized content to a search engine spider upon request; and
serving the proxy web pages including the optimized content to a web browser when the web browser selects the search results listing for the proxy web page from the search engine results page.

20. The method of claim 19 further comprising the steps of:
receiving a request from the web browser at the proxy website for the proxy web page;
retrieving the corresponding web page from the commercial website;
processing the web page from the commercial website to remove dynamic URLs to create the proxy web page; and
presenting the proxy web page to the web browser.

21. The method of claim 19 further comprising the step of tracking the ranking of the proxy web pages on the search engine results page based upon the addition or revision of the optimized content.

22. The method of claim 19 further comprising the step of adding an optimized web page to the proxy website, wherein the optimized web page does not include a corresponding web page on the commercial website.
